(19) United States
(12) Patent Application Publication
(10) Pub. No.: US 2012/0100431 A1
(43) Pub. Date: Apr. 26, 2012

(54) CATHODE ACTIVE MATERIAL AND NONAQUEOUS SECONDARY BATTERY INCLUDING CATHODE HAVING THE CATHODE ACTIVE MATERIAL

(76) Inventors: Takeshi YAO, Kyoto-shi (JP); Shogo Esaki, Osaka-shi (JP); Motoaki Nishijima, Osaka-shi (JP)

(21) Appl. No.: 13/275,807

(22) Filed: Oct. 18, 2011

(30) Foreign Application Priority Data
Oct. 22, 2010 (JP) 2010-237458

(51) Int. Cl. H01M 4/131; H01M 4/505; B82Y 99/00

(52) U.S. Cl. 429/231.1; 252/182.1; 977/773

(57) ABSTRACT

A cathode active material of the present invention for use in a nonaqueous secondary battery, the cathode active material includes: a main crystalline phase including a lithium-containing transition metal oxide containing manganese and having a spinel structure; and a sub crystalline phase contained in the main crystalline phase, the sub crystalline phase being identical in oxygen arrangement to the lithium-containing transition metal oxide and different in elementary composition from the lithium-containing transition metal oxide, a main crystalline phase part around the sub crystalline phase and the sub crystalline phase having a same crystal orientation.

This Nonprovisional application claims priority under 35 U.S.C. §119(a) on Patent Application No. 2010-237458 filed in Japan on Oct. 22, 2010, the entire contents of which are hereby incorporated by reference.

### TECHNICAL FIELD

The present invention relates to a cathode active material for producing a long-lived nonaqueous electrolyte secondary battery. In particular, the present invention relates to a nonaqueous electrolyte secondary battery which is improved in storability and cycle life of charging/discharging.

### BACKGROUND ART

Conventionally, nonaqueous secondary batteries have often been used as a power source for portable devices, in view of their economical efficiency and like aspects. Various types of nonaqueous secondary batteries are available: the most common type of the nonaqueous secondary batteries is a nickel-cadmium battery; and recently nickel-metal hydride batteries are also becoming more available.

From among the nonaqueous secondary batteries, a lithium secondary battery that uses lithium has been partially put to practical use due to their high output potential and their high energy density. Moreover, studies on the lithium secondary battery have been eagerly conducted in recent years, to achieve an even higher performance. Currently, LiCoO₂ is available on the market as a cathode material of the lithium secondary battery. However, due to the expensiveness of cobalt that is used as the raw material of LiCoO₂, LiMn₂O₄ using manganese, a cheaper raw material than cobalt, has been receiving attention.

However, with LiMn₂O₄, repetition of a charging/discharging cycle causes Mn contained in the cathode active material to solve out as Mn ions, and Mn thus solved out is separated on an anode as a metal Mn in the charge and discharging process. The metal Mn separated on the anode reacts with lithium ions in an electrolytic solution, and as a result, causes a remarkable decrease in capacity of a battery.

Various methods have been employed to solve this problem. For instance, Patent Literature 1 discloses a method that covers particle surfaces of manganese oxides with a polymer to prevent manganese from solving out, and Patent Literature 2 discloses a method that covers the particle surfaces of manganese oxides with boron, to prevent manganese from solving out.

Moreover, Patent Literature 3, Patent Literature 4, and Non-patent Literature 1 disclose a technique which, in order to prevent manganese from solving out, includes a substance having a different composition not including a transition element inside the LiMn₂O₄ crystal but having a similar configuration as the LiMn₂O₄ crystal in an electrode material.

### CITATION LIST

### Patent Literatures

Patent Literature 1

Japanese Patent Application Publication, Tokukai, No. 2000-231919 A (Publication Date: Aug. 22, 2000)

Patent Literature 2

Japanese Patent Application Publication, Tokukaihei, No. 9-265984 A (Publication Date: Oct. 7, 1997)

Patent Literature 3

Japanese Patent Application Publication, Tokukai, No. 2001-176513 A (Publication Date: Jun. 29, 2001)

Patent Literature 4

Japanese Patent Application Publication, Tokukai, No. 2003-272631 A (Publication Date: Sep. 26, 2003)

### Non-Patent Literature

Non-Patent Literature 1

Mitsuhiro Hibino, Masayuki Nakamura, Yuji Kamitaka, Naoshi Ozawa and Takeshi Yao, Solid State Ionics Volume 177, Issues 26-32, 31 Oct. 2006, Pages 2653-2656.

### SUMMARY OF INVENTION

### Technical Problem

Although the conventional configuration prevents the loss of Mn from the cathode active material, the conventional configuration becomes the cause of other problems.

Specifically, each of the cathode active material disclosed in Patent Literature 1 and Patent Literature 2 has the surface of LiMn2O4 be coated with a different insulating substance; this causes a remarkable increase in electric resistance from the LiMn2O4 particles. Hence, there is a drawback that output characteristics of the battery are deteriorated.

Moreover, although the cathode active material disclosed in Patent Literature 3, Patent Literature 4, and Non Patent Literature 1 have their high temperature characteristics improved by including, into the electrode material, a substance having a structure similar to the LiMn₂O₄ crystal to prevent manganese from solving out from LiMn₂O₄ upon charging or discharging the secondary battery, this does not solve the problem in cycle characteristics at room temperature.

The present invention is accomplished in view of the foregoing problem, and its object is to produce a long-lived cathode active material in which solving out of Mn is prevented, while mixing no additives etc. into the electrolyte.

### Solution to Problem

In order to solve the foregoing problems, a cathode active material of the present invention is a cathode active material for use in a nonaqueous secondary battery, the cathode active material including: a main crystalline phase including a lithium-containing transition metal oxide containing manganese and having a spinel structure; and a sub crystalline phase contained in the main crystalline phase, the sub crystalline phase being identical in oxygen arrangement to the lithium-containing transition metal oxide and different in elementary composition from the lithium-containing transition metal oxide, a main crystalline phase part around the sub crystalline phase and the sub crystalline phase having a same crystal orientation.

With the arrangement, in the case where the cathode active material is used as a cathode material of a nonaqueous secondary battery, the sub crystalline phase is not involved in a charge/discharge reaction. The sub crystalline phase can thus physically prevent expansion or shrinkage of the cathode active material which expansion or shrinkage is caused when lithium is eliminated from or inserted into the main crystalline phase. Further, in the cathode active material, the main crystalline phase part around the sub crystalline phase and the sub crystalline phase have the same crystal orientation. Having the same crystal orientation indicates that adjacent crystals have the same crystal orientation. That is, in the cathode active material of the present invention, the sub crystalline phase and the main crystalline phase part around the sub crystalline phase have a continuous crystal structure. This enables the sub crystalline phase to be stably present in the main crystalline phase. Accordingly, the cathode active material of the present invention has a structure which enables the sub crystalline phase capable of preventing expansion or shrinkage of the main crystalline phase to be stably present in the main crystalline phase. With this arrangement, when the cathode active material is used as a cathode material of a nonaqueous secondary battery, crystal particles included in the cathode active material are less likely to be deformed. As a result, it is possible to (i) reduce the risk of, for example, a crack or breaking occurring in the crystal particles and consequently to (ii) provide a cathode active material that enables production of a nonaqueous electrolyte secondary battery which is less likely to have a reduced discharge capacity.

### Advantageous Effects of Invention

The cathode active material of the present invention is a cathode active material for use in a nonaqueous secondary battery, the cathode active material including: a main crystalline phase including a lithium-containing transition metal oxide containing manganese and having a spinel structure; and a sub crystalline phase contained in the main crystalline phase, the sub crystalline phase being identical in oxygen arrangement to the lithium-containing transition metal oxide and different in elementary composition from the lithium-containing transition metal oxide, a main crystalline phase part around the sub crystalline phase and the sub crystalline phase having a same crystal orientation.

Thus, with the above arrangement, the sub crystalline phase can function as a barrier for preventing Mn from solving out, thus reducing the solving out of Mn. As a result, it is possible to provide a cathode active material that enables production of a nonaqueous electrolyte secondary battery having greatly improved cycle characteristics. In the cathode active material of the present invention, the sub crystalline phase and the main crystalline phase part around the sub crystalline phase have a continuous crystal structure. This enables the sub crystalline phase to be stably present in the main crystalline phase. Accordingly, the sub crystalline phase capable of preventing expansion or shrinkage of the main crystalline phase can be stably present in the main crystalline phase.

With this arrangement, when the cathode active material is used as a cathode material of a nonaqueous secondary battery, crystal particles included in the cathode active material are less likely to be deformed. As a result, it is possible to (i) reduce the risk of, for example, a crack or breaking occurring in the crystal particles and consequently to (ii) provide a cathode active material that enables production of a nonaqueous electrolyte secondary battery which is less likely to have a reduced discharge capacity.

### BRIEF DESCRIPTION OF DRAWINGS

FIG. 1 is a perspective view illustrating a configuration of a cathode active material in accordance with an embodiment of the present invention.

FIG. 2 is a drawing showing a photographed HAADF-STEM image of a cathode active material obtained in Example 1.

FIG. 3 is a drawing showing a photographed EDX-element map of the cathode active material obtained in Example 1.

FIG. 4(a) of FIG. 4 is a drawing showing a photographed HAADF-STEM image of the cathode active material obtained in Example 1. (b) of FIG. 4 is a drawing showing a photographed result of electron diffraction of the cathode active material obtained in Example 1.

FIG. 5 is a drawing showing a photographed lattice image of the cathode active material obtained in Example 1.

FIG. 6 is a drawing showing a photographed HAADF-STEM image of a cathode active material obtained in Example 2.

FIG. 7 is a drawing showing a photographed EDX-element map of the cathode active material obtained in Example 2.

FIG. 8(a) of FIG. 8 is a drawing showing a photographed HAADF-STEM image of the cathode active material obtained in Example 2. (b) of FIG. 8 is a drawing showing a photographed result of electron diffraction of the cathode active material obtained in Example 2.

FIG. 9 is a drawing showing a photographed HAADF-STEM image of a cathode active material obtained in Example 3.

FIG. 10 is a drawing showing a photographed EDX-element map of the cathode active material obtained in Example 3.

FIG. 11 is a drawing showing a photographed HAADF-STEM image of a cathode active material obtained in Example 3.

FIG. 12 is a drawing showing a photographed result of electron diffraction of the cathode active material obtained in Example 3.

FIG. 13 is a drawing showing a photographed HAADF-STEM image of a cathode active material obtained in Comparative Example 1.

FIG. 14 is a drawing showing a photographed EDX-element map of the cathode active material obtained in Comparative Example 1.

FIG. 15(a) of FIG. 15 is a drawing showing a photographed HAADF-STEM image of the cathode active material obtained in Comparative Example 1. (b) of FIG. 15 is a drawing showing a photographed result of electron diffraction of the cathode active material obtained in Comparative Example 1.

FIG. 16 is a drawing showing photographed electron diffraction of a cathode active material obtained in Comparative Example 2.

### DESCRIPTION OF EMBODIMENTS

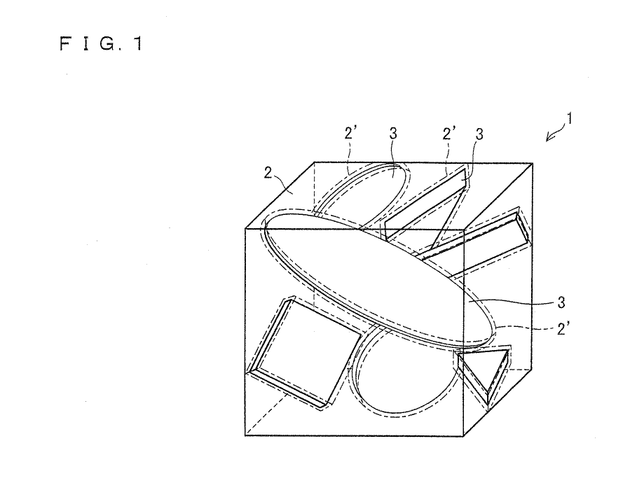

One embodiment of the present invention is described below with reference to FIG. 1. The present specification as appropriate uses (i) the term “cathode active material” to refer to a cathode active material used in a nonaqueous secondary battery, (ii) the term “cathode” to refer to a cathode used in a nonaqueous secondary battery, and (iii) the term “secondary battery” to refer to a nonaqueous secondary battery. Further, the nonaqueous secondary battery is equal to a nonaqueous electrolyte secondary battery.

A cathode active material of the present invention is a cathode active material for use in a nonaqueous secondary battery, the cathode active material including: a main crystalline phase including a lithium-containing transition metal oxide containing manganese and having a spinel structure; and a sub crystalline phase which is contained in the main crystalline phase, the sub crystalline phase being identical in oxygen arrangement to the lithium-containing transition metal oxide and different in elementary composition from the lithium-containing transition metal oxide, a main crystalline phase part around the sub crystalline phase and the sub crystalline phase having the same crystal orientation. In the description below, the term “lithium-containing transition metal oxide” is also referred to as “lithium-containing oxide” as appropriate.

<Cathode Active Material>

[Main Crystalline Phase]

A cathode active material according to the present invention has a main crystalline phase as its main phase. The main crystalline phase includes a lithium-containing oxide that contains manganese. The lithium-containing oxide, which normally has a spinel structure, can be used as the lithium-containing oxide of the present invention even if it does not have a spinel structure.

The lithium-containing oxide specifically has a composition including at least lithium, manganese, and oxygen. The lithium-containing oxide can further include a transition metal other than manganese in addition to manganese. The transition metal other than manganese is not particularly limited, provided that it does not obstruct a function of the cathode active material. Specific examples of the transition metal encompass Ti, V, Cr, Fe, Cu, Ni, and Co.

The lithium-containing oxide, however, preferably includes only manganese as the transition metal because the lithium-containing oxide can, in such a case, be synthesized easily.

In the case where the lithium-containing oxide has a spinel structure, it has a composition ratio that can be expressed as Li:M:O=1:2:4, where M is either manganese or a combination of manganese and at least one transition metal other than manganese.

In a case of a lithium-containing oxide with a spinel structure, however, its composition ratio often varies from Li:M:O=1:2:4 in practice. This also applies to the cathode active material according to the present invention. An example non-stoichiometric compound with a composition ratio different from the above in terms of oxygen content is Li:M:O=1:2:3.5-4.5 or 4:5:12.

In a case where the cathode active material of the present invention includes only a small proportion of the lithium-containing oxide, a secondary battery including the cathode active material as a cathode material may have a reduced discharge capacity. Hence, if the cathode active material has an overall composition including the main crystalline phase and the sub crystalline phase which overall composition is expressed as

Li₁₋ₓM1₂₋₂ₓM2ₓM3₂ₓO_{4-y} (General Formula A),

wherein M1 is either manganese or a combination of manganese and at least one other transition metal element; M2 and M3 are each at least one representative metal element or at least one transition metal element; M1, M2, and M3 are different from one another; and y is a value that satisfies electrical neutrality with x. In General Formula A, x is preferably 0.01≦x≦0.10, and is more preferably 0.03≦x≦0.07. Further, y is a value that satisfies electrical neutrality with x, and may be 0.

In the case where x falls within the above range, it is possible to achieve preferable proportions for the main crystalline phase and the sub crystalline phase. Further, in a case where the cathode active material is used as a cathode material of a nonaqueous secondary battery, it is possible to achieve a suitable balance between (i) prevention of reduction in discharge capacity of the nonaqueous secondary battery and (ii) improvement of cycle characteristics of the nonaqueous secondary battery.

M1 may be, as a specific example, either only Mn or a combination of Mn and at least one other transition metal element. The transition metal element may specifically be any of elements such as Ti, V, Cr, Fe, Cu, Ni, and Co.

M2 and M3 are not particularly limited. As specific examples, (i) M2 is Sn while M3 is Zn, or (ii) M2 is Sn while M3 is Co.

A transition metal is (i) an element that has a d orbital incompletely filled with electrons or (ii) an element that generates such a positive ion, whereas a representative element denotes any other element. For example, a zinc atom Zn has an electron configuration of 1s²2s²2p⁶3s²3p⁶4s²3d¹⁰, whereas a positive ion of zinc, which is Zn²⁺, has an electron configuration of 1s²2s²2p⁶3s²3p⁶3d¹⁰. The atom and the positive ion both have 3d¹⁰, and thus neither of them has an incompletely filled d orbital. Zn is therefore a representative element.

The main crystalline phase can have a crystal structure which is a cubic crystal, a tetragonal crystal, an orthorhombic crystal, a monoclinic crystal, a trigonal crystal, a hexagonal crystal, or a triclinic crystal. The crystal structure may further be different from any of the above.

A crystal orientation indicates a relative relationship between a sample coordinate system and a crystal coordinate system. Sameness in crystal orientation indicates sameness in orientation between adjacent crystals. In this case, crystals are continuous, so that a sub crystalline phase can be stably present in a main crystalline phase. On the other hand, difference in crystal orientation indicates difference in orientation between adjacent crystals. In this case, crystals are discontinuous, so that a sub crystalline phase cannot be stably present in a main crystalline phase.

[Sub Crystalline Phase]

The sub crystalline phase of the present invention includes a compound which is identical in oxygen arrangement to the above lithium-containing oxide and which is different in elementary composition from the lithium-containing oxide. In other words, the sub crystalline phase includes a compound which is different from the lithium-containing oxide and which is identical in oxygen arrangement to the lithium-containing oxide. Being identical in oxygen arrangement as such means that the sub crystalline phase and the lithium-containing oxide each have an oxygen arrangement based on a cubic closest packed structure. The oxygen arrangement does not necessarily have a perfect cubic closest packed structure: Specifically, the oxygen arrangement can be distorted in any axis direction, or have an oxygen defective portion or regularly occurring oxygen defects. The sub crystalline phase can have a crystal structure which is a cubic crystal, a tetragonal crystal, an orthorhombic crystal, a monoclinic crystal, a trigonal crystal, a hexagonal crystal, or a triclinic crystal. The crystal structure may further be different from any of the above.

In the cathode active material of the present invention, the sub crystalline phase has the same oxygen arrangement as the lithium-containing oxide. The sub crystalline phase can, via the same oxygen arrangement, bond to the main crystalline phase with good affinity. The sub crystalline phase can thus be stably present in the main crystalline phase. In a case where the main crystalline phase is a cubic crystal while the sub crystalline phase is a tetragonal crystal or an orthorhombic crystal, there can normally occur a mismatch therebetween because the crystal structure is different from each other and the oxygen arrangement is subtly different from each other in consequence. The mismatch increases with an increasing thickness of the sub crystalline phase. Therefore, it is preferable that the sub crystalline phase is thin without being thick, and specifically the sub crystalline phase is in a layer. Consequently, even in a case where the sub crystalline phase is other than a cubic crystal in its crystal structure, the sub crystalline phase can be present in the main crystalline phase with high affinity in the cathode active material of the present invention.

The sub crystalline phase preferably has a thickness ranging from 1 nm to 100 nm. When the thickness of the sub crystalline phase is in the above range, it is possible to preferably secure a thickness of the sub crystalline phase which thickness enables reducing solving out of Mn, and it is also possible to subdue an inconvenience such as too much thickness of the sub crystalline phase prevents Li ions from moving from the cathode active material.

An example of a compound having a cubic crystal is MgAl₂O₄. An example of a compound having a tetragonal crystal is ZnMn₂O₄. An example of a compound having an orthorhombic crystal is CaMn₂O₄. The composition of the sub crystalline phase is not necessarily stoichiometric: The sub crystalline phase may include Mg or Zn partially substituted by another element such as Li, or Mg or Zn partially defected.

In a case where the sub crystalline phase has a spinel structure, the sub crystalline phase can be present on the interface of the main crystalline phase with desirably higher affinity.

The sub crystalline phase preferably contains a representative element and manganese. In a case where the sub crystalline phase has a composition including manganese and a representative element as such, it is possible to further stabilize the sub crystalline phase which bonds to the main crystalline phase via an identical oxygen arrangement. Consequently, it is possible to further reduce the solving out of Mn from the main crystalline phase.

The above representative element is not particularly limited, and can be an element such as magnesium, potassium, and zinc.

The sub crystalline phase preferably contains zinc and manganese. In a case where the sub crystalline phase has a composition including zinc and manganese, it is possible to further stabilize the sub crystalline phase which bonds to the main crystalline phase via an identical oxygen arrangement. Consequently, it is possible to particularly desirably reduce the solving out of Mn from the main crystalline phase.

In particular, in the case where the sub crystalline phase contains zinc and manganese, the sub crystalline phase has a composition ratio Mn/Zn of manganese and zinc which composition ratio is preferably 2≦Mn/Zn<4 and more preferably 2≦Mn/Zn<3.5. In a case where the composition ratio of manganese and zinc falls within the above range, it is possible to further reduce the solving out of Mn from the main crystalline phase.

In a case where the main crystalline phase is a cubic crystal or is nearly a cubic crystal, the lithium-containing oxide of the main crystalline phase preferably has a lattice constant of not less than 8.22 Å and not greater than 8.25 Å. In a case where the lithium-containing oxide has a lattice constant which falls within the above range, a distance between and arrangement of oxygen atoms on any plane of the sub crystalline phase which is identical in oxygen arrangement to the main crystalline phase match the lattice constant of the lithium-containing oxide. This allows the sub crystalline phase to bond to the main crystalline phase with good affinity. As such, the sub crystalline phase can stably be present on the interface of the main crystalline phase.

In the cathode active material of the present invention, it is preferable that the sub crystalline phase and the main crystalline phase part are formed in such a manner that the 011 plane of the main crystalline phase part and the 001 plane of the sub crystalline phase are adjacent to each other. Such formation enables a distance between and arrangement of oxygen atoms on the 011 plane of the main crystalline phase part to match those of oxygen atoms on the 001 plane of the sub crystalline phase. This enables the sub crystalline phase and the main crystalline phase to bond to each other with higher affinity. Consequently, the sub crystalline phase can be more stably present on the interface of the main crystalline phase.

In the cathode active material of the present invention, the sub crystalline phase is formed inside the main crystalline phase. As such, in the case where the cathode active material is used as a cathode material of a secondary battery, the sub crystalline phase formed in the main crystalline phase can physically block Mn solving out from the cathode active material to an electrolyte during charging/discharging. In other words, the sub crystalline phase can function as a barrier for preventing Mn from solving out, thus reducing the solving out of Mn. As a result, it is possible to provide a cathode active material that enables production of a nonaqueous secondary battery having greatly improved cycle characteristics.

Further, as described above, it is preferable that the sub crystalline phase is formed in the shape of a layer. Consequently, in the case where the cathode active material is used as a cathode material of a secondary battery, the layer-shaped sub crystalline phase can physically preferably block Mn solving out from the cathode active material to an electrolyte during charging/discharging. In other words, the sub crystalline phase can further reduce solving out of Mn. As a result, it is possible to provide a cathode active material that enables production of a nonaqueous secondary battery having further greatly improved cycle characteristics.

FIG. 1 is a perspective view illustrating a cathode active material 1 of the present embodiment. As illustrated in FIG. 1, the cathode active material 1 includes a main crystalline phase 2, which in turn includes a sub crystalline phase 3. In other words, the sub crystalline phase 3 is covered by the main crystalline phase 2. In the cathode active material 1, the sub crystalline phase 3 is formed in the preferable shape of a layer. With this arrangement, in a case where Mn solves out from the main crystalline phase 2, the sub crystalline phase 3 functions as a barrier so as to preferably prevent Mn from solving out. Even in a case where the sub crystalline phase 3 is contained in the cathode active material 1 in a small amount, the sub crystalline phase 3, which has a layer shape, can cover the lithium-containing oxide, and thus prevents Mn from solving out.

The layer shape of the sub crystalline phase 3 can be verified by observing the cathode active material 1 under a publicly known electron microscope. The electron microscope can be a HAADF-STEM (high-angle annular dark-field scanning transmission electron microscope), for example.

A main crystalline phase part 2′ indicates a part of the main crystalline phase 2 which part is positioned around the sub crystalline phase 3. Accordingly, the main crystalline phase part 2′ is adjacent to the sub crystalline phase 3. A crystal orientation of the main crystalline phase part 2′ is the same as a crystal orientation of the sub crystalline phase 3. The sameness in crystal orientation indicates the sameness in crystal orientation between adjacent crystals. That is, the cathode active material of the present invention has a crystal structure in which the sub crystalline phase and the main crystalline phase part are positioned continuously, and accordingly the sub crystalline phase 3 can be stably present in the main crystalline phase 2.

The term “around the sub crystalline phase 3” is not particularly limited, and may be construed as “in an area from the surface of the sub crystalline phase 3 by 1 nm or more and 500 nm or less”. The term “around the sub crystalline phase 3” may be rephrased as “in the periphery of the sub crystalline phase 3”.

Further, in a preferred embodiment, the main crystalline phase part 2′ and the sub crystalline phase 3 are formed in such a manner that the 011 phase of the main crystalline phase part 2′ is adjacent to the 001 phase of the sub crystalline phase 3. Such formation enables a distance between and arrangement of oxygen atoms on the 011 plane of the main crystalline phase part 2′ to match those of oxygen atoms on the 001 plane of the sub crystalline phase 3. This enables the sub crystalline phase 3 and the main crystalline phase 2 to bond to each other with higher affinity. Consequently, the sub crystalline phase 3 can be more stably present on the interface of the main crystalline phase 2.

In a case where the cathode active material of the present invention contains a large amount of the sub crystalline phase, a relative amount of the lithium-containing oxide is reduced in a secondary battery including the cathode active material as a cathode material. As a result, the cathode active material may have a reduced discharge capacity. On the other hand, in a case where the cathode active material of the present invention contains a small amount of the sub crystalline phase, the sub crystalline phase has a reduced effect of preventing Mn from solving out of the main crystalline phase. This will undesirably reduce the effect of improving cycle characteristics of the secondary battery.

In view of this, x in the General Formula A falls preferably within a range of 0.01≦x≦0.10, and more preferably within a range of 0.03≦x≦0.07. With x within one of the above ranges, a proportion of the sub crystalline to the cathode active material falls within a preferable range. As such, it is possible to achieve a good balance between prevention of reduction in discharge capacity and improvement of cycle characteristics.

The inventors of the present invention has further discovered as a result of diligently studies that the sub crystalline phase in the main crystalline phase preferably has a crystallinity which is detectable by diffractometry (crystal diffractometry). With this arrangement, the sub crystalline phase has a high crystallinity. As such, in the case where the cathode active material is used as a cathode material of a secondary battery, it is possible to physically prevent expansion or shrinkage of the cathode active material which expansion or shrinkage is caused when lithium is eliminated from or inserted into the main crystalline phase. With this arrangement, crystal particles included in the cathode active material are less likely to be deformed. As a result, it is possible to (i) reduce the risk of, for example, a crack occurring in the crystal particles and consequently to (ii) provide a cathode active material that enables production of a secondary battery which is less likely to have a reduced discharge capacity.

<Method for Producing Secondary Battery>

The following description deals with a method for producing a secondary battery. The description first deals with a method for preparing a raw material for the cathode active material, that is, a raw material compound for the sub crystalline phase.

[Preparation of Raw Material Compound for Sub Crystalline Phase]

Preparation of a raw material compound for the sub crystalline phase, that is, a spinel-type compound, is not particularly limited in method. The method can be a publicly known method such as a solid phase method and a hydrothermal method. The method can alternatively be sol-gel process or spray pyrolysis.

In a case where the spinel-type compound is prepared by a solid phase method, the spinel-type compound is made of a raw material which contains an element to be contained in the sub crystalline phase. The raw material can be an oxide or a chloride such as a carbonate, a nitrate, a sulfate, and a hydrochloride, each of which includes the above element.

Specific examples of the raw material include manganese dioxide, manganese carbonate, manganese nitrate, lithium oxide, lithium carbonate, lithium nitrate, magnesium oxide, magnesium carbonate, magnesium nitrate, calcium oxide, calcium carbonate, calcium nitrate, aluminum oxide, aluminum nitrate, zinc oxide, zinc carbonate, zinc nitrate, iron oxide, iron carbonate, iron nitrate, tin oxide, tin carbonate, tin nitrate, titanium oxide, titanium carbonate, titanium nitrate, vanadium pentoxide, vanadium carbonate, vanadium nitrate, cobalt oxide, cobalt carbonate, and cobalt nitrate.

The raw material can alternatively be a hydrolysate Meₓ(OH)ₓ of a metal alkoxide containing an element Me to be contained in the sub crystalline phase (where Me represents an element such as manganese, lithium, magnesium, aluminum, zinc, iron, tin, titanium, and vanadium, and the above x represents a valence of the element Me). The raw material can further alternatively be a metal ion solution containing the element Me. The metal ion solution is used as the above raw material in a state where it is mixed with a thickening agent or a chelating agent.

The thickening agent can be a publicly known thickening agent, and is not particularly limited. The thickening agent is, for example, ethylene glycol or carboxymethyl cellulose. The chelating agent can also be a publicly known chelating agent, and is not particularly limited. The chelating agent for example, ethylenediaminetetraacetic acid or ethylenediamine.

The spinel-type compound can be prepared by mixing and baking the above raw material so that the element is contained in the raw material in such an amount that the sub crystalline phase will have an intended composition ratio. The baking is carried out at a temperature which is set depending on the kind of the raw material to be used. The baking temperature thus cannot be easily specified by a particular value. In general, however, the baking can be carried out at a temperature which is not lower than 400° C. and not higher than 1500° C. The baking can be carried out in an inert atmosphere or in an oxygen-containing atmosphere.

The spinel-type compound can also be synthesized by a hydrothermal method, which (i) dissolves, in an alkaline aqueous solution in an airtight container, a substance such as an acetate and a chloride as the raw material containing the element to be contained in the spinel-type compound and (ii) heats the resulting solution. In a case where the spinel-type compound is synthesized by a hydrothermal method, the resulting spinel-type compound can be (i) directly used in a process below of producing the cathode active material or (ii) used in the process of producing the cathode active material after the resulting spinel-type compound has been subjected to a treatment such as a heat treatment.

In a case where the spinel-type compound prepared by the above method has an average particle size of greater than 100 μm, it is preferable to reduce the average particle size. The particle size can be reduced by, for example, (i) crushing the spinel-type compound in a mortar, a planetary ball mill etc. or (ii) classifying the spinel-type compound according to the particle size with use of a mesh etc. so that the spinel-type compound with a small average particle diameter is used in a subsequent process.

[Production of Cathode Active Material]

The spinel-type compound prepared as above is next synthesized in a single phase and is then either (1) mixed with (i) a lithium source material serving as a raw material for a lithium-containing oxide and (ii) a manganese source material and baked, or (2) mixed with a separately synthesized lithium-containing oxide and baked. This produces a cathode active material. As described above, the cathode active material of the present embodiment is produced by a method using a spinel-type compound prepared in advance.

The following describes a case of the method (1) above. First, the spinel-type compound is compounded with (i) a lithium source material corresponding to a desired lithium-containing oxide and (ii) a manganese source material.

Examples of the lithium source material include lithium carbonate, lithium hydroxide, and lithium nitrate. Examples of the manganese source material include manganese dioxide, manganese nitrate, and manganese acetate. The manganese source material is preferably electrolytic manganese dioxide.

The manganese source material can be used in combination with a transition metal raw material containing a transition metal other than manganese. Examples of the transition metal include Ti, V, Cr, Fe, Cu, Ni, and Co. Examples of the transition metal raw material include an oxide of the transition metal, and a chloride such as a carbonate and hydrochloride, of the transition metal.

The method, after selecting a lithium source material and a manganese source material (including a transition metal raw material) to be mixed with the spinel-type compound, compounds the lithium source material and the manganese source material (including the transition metal raw material) with the spinel-type compound so that a desired ratio for the lithium-containing oxide is achieved by (i) a proportion of Li in the lithium source material and (ii) a proportion of the manganese source material (including the transition metal raw material). In a case where, for example, the desired lithium-containing oxide is LiM₂O₄ (where M represents (i) manganese or (ii) a combination of manganese and at least one transition metal other than manganese), the lithium source material and the manganese source material (including the transition metal raw material) are compounded with each other in their respective amounts so that a ratio of Li to M is 1:2.

The method, after compounding the spinel-type compound, the lithium source material, and the manganese source material in their respective amounts, uniformly mixes them (mixing step). The spinel-type compound, the lithium source material, and the manganese source material are preferably compounded with one another in their respective amounts so that x in General Formula A above falls within the range of 0.01≦x≦0.10. With x within the range, it is possible to produce a cathode active material of the present invention by carrying out baking at a below-described baking temperature for a below-described baking period. The above mixing can be carried out in a publicly known mixing device such as a mortar and a planetary ball mill.

The spinel-type compound, the lithium source material, and the manganese source material can be mixed with one another in their respective total amounts in a single operation. Alternatively, the lithium source material and the manganese source material can each be added in separate small portions to the total amount of the spinel-type compound for the mixing. The alternative case is preferable because it can (i) gradually reduce a concentration of the spinel-type compound and consequently (ii) carry out the mixing more uniformly.

The method next carries out pre-baking with respect to the mixed raw materials (pre-baking step). The pre-baking carries out baking as a pre-treatment preceding a baking step described below. The pre-baking can be carried out in an air atmosphere or in an atmosphere with an increased oxygen concentration. This condition also applies to the baking step described below.

The pre-baking step has a preferable baking temperature and a preferable baking period which vary as appropriate depending on (i) the raw materials mixed and (ii) the value of x in General Formula A expressing the cathode active material. It is thus difficult to specify a particular value for a preferable baking temperature or a preferable baking period. In general, however, (i) the baking temperature can be not lower than 400° C. and not higher than 600° C., and preferably not lower than 400° C. and not higher than 550° C., and (ii) the baking period can be 12 hours.

The pre-baking is followed by further baking (baking step) so as to produce a cathode active material. The mixed raw materials are preferably pressed so as to have a pellet shape for convenience of the baking before being baked. The baking is carried out at a temperature which depends on kinds of the mixed raw materials. In general, however, the baking temperature is not lower than 400° C. and not higher than 1000° C. In a case where the baking is carried out for an extended period of time, the sub crystalline phase will have an excessively large thickness. Thus, the baking period is preferably not longer than 16 hours. On the other hand, in a case where the baking is carried out for a short period of time, the sub crystalline phase will have a small thickness. Thus, the baking period preferably has a lower limit of 0.5 hour.

With the baking period within the above range, there can exist, on an interface between the main crystalline phase and the sub crystalline phase in a cathode active material to be produced, an intermediate phase including at least a part of elements of the main crystalline phase and at least a part of elements of the sub crystalline phase. Such an interface allows the main crystalline phase and the sub crystalline phase to strongly bond to each other, and consequently enables production of a cathode active material in which a crack etc. is even less likely to occur.

The interface refers to a boundary at which the main crystalline phase and the sub crystalline phase are in contact with each other. Further, the intermediate phase refers to a region present on the interface between the main crystalline phase and the sub crystalline phase in which region elements of the main crystalline phase are mixed with elements of the sub crystalline phase. The intermediate phase contains a mixture of the elements of the main crystalline phase and those of the sub crystalline phase in their respectively different proportions. The intermediate phase is different from either of the main crystalline phase and the sub crystalline phase, and includes at least one compound including (i) all or a part (at least a part) of the elements of the main crystalline phase and (ii) all or a part (at least a part) of the elements of the sub crystalline phase.

The compound can also be a solid solution. The elements included in the intermediate phase can vary in their respective proportions depending on a location. For example, the elements of the intermediate phase can presumably vary in proportion between a location close to the main crystalline phase and a location close to the sub crystalline phase.

Whether the main crystalline phase and the sub crystalline phase are forming a solid solution can be verified by X-ray diffractometry. Specifically, for example, the main crystalline phase and the sub crystalline phase are determined to be not forming a solid solution if (i) respective peaks of the main crystalline phase and the sub crystalline phase can be detected, (ii) the detected peak of the main crystalline phase in that state is not shifted in position from a peak of the main crystalline phase when it is present by itself and (iii) the detected peak of the sub crystalline phase in the above state (state where respective peaks of the main crystalline phase and the sub crystalline phase can be detected) is not shifted in position from a peak of the sub crystalline phase when it is present by itself. On the other hand, if, for example, the sub crystalline phase is forming a solid solution with the main crystalline phase, X-ray diffractometry cannot detect a peak of the sub crystalline phase, and further, the main crystalline phase has an X-ray diffractometry profile having a peak which is shifted from a peak of the main crystalline phase when not forming a solid solution. Note that the expression “forming a solid solution” as used herein refers to formation of a solid solution by at least a portion of the main crystalline phase and at least a portion of the sub crystalline phase. Such formation of a solid solution is not limited in respective proportions of the main crystalline phase or the sub crystalline phase.

It is not preferable to carry out the baking for such an extended period of time that the sub crystalline phase may be dispersed in the main crystalline phase in its total amount so that a uniform solid solution is formed. In a case where a complete solid solution is formed, the sub crystalline phase cannot be formed inside the main crystalline phase.

A highly preferable method for producing a cathode active material is to (i) synthesize Zn₂SnO₄ in a single phase, Zn₂SnO₄ being a spinel compound including a part of the raw material of the sub crystalline phase, and then (ii) mix a lithium source material with a manganese source material and bake the mixture. This greatly improves cycle characteristics of a secondary battery to be produced.

[Production of Cathode]

The cathode active material produced as above is processed into a cathode through publicly known steps below. The cathode is produced from a combination agent obtained by mixing the cathode active material, a conductive material, and a binding agent.

The conductive material can be a publicly known conductive material, and is not particularly limited to a specific one. Examples of the conductive material include (i) a carbon such as carbon black, acetylene black, and Ketjen Black, (ii) graphite (either natural graphite or artificial graphite) powder, metal powder, and (iv) metal fiber.

The binding agent can be a publicly known binding agent, and is not particularly limited to a specific one. Examples of the binding agent include (i) a fluorine polymer such as polytetrafluoroethylene and polyvinylidene fluoride, (ii) a polyolefin polymer such as polyethylene, polypropylene, and ethylene-propylene-diene terpolymer, and (iii) styrene-butadiene-rubber.

Appropriate mixing proportions of the conductive material and the binding agent vary depending on kinds of the conductive material and the binding agent to be mixed, and each cannot easily be specified by a particular value. In general, however, (i) the conductive material can be mixed in an amount which is not less than 1 part by weight and not greater than 50 parts by weight, and (ii) the binding agent can be mixed in an amount which is not less than 1 parts by weight and not greater than 30 parts by weight, both with respect to 100 parts by weight of the cathode active material.

If the conductive material is mixed in a proportion which is less than 1 parts by weight, the resulting cathode will be large in resistance, polarization etc., and will thus have a small discharge capacity. This makes it impossible to produce a practical secondary battery with use of the cathode obtained. On the other hand, if the conductive material is mixed in a proportion which is greater than 50 parts by weight, the resulting cathode will have a reduced mixing proportion of the cathode active material, and will thus have a small discharge capacity.

If the binding agent is mixed in a proportion which is less than 1 part by weight, the binding agent may not achieve its binding effect. On the other hand, if the binding agent is mixed in a proportion which is greater than 30 parts by weight, the resulting cathode will, as in the case of the conductive material, have a reduced mixing proportion of the cathode active material. Further, the cathode will be large in resistance, polarization etc. similarly to the above case, and will thus unpractically have a small discharge capacity.

The combination agent can further include a filler, a dispersing agent, an ion conductor, a pressure enhancing agent, and any of other various additives in addition to the conductive material and the binding agent. The filler is not particularly limited to a specific one, provided that it is a fibrous material that does not chemically change in a secondary battery to be produced. The filler is typically an olefin polymer such as polypropylene and polyethylene or fiber made of, for example, glass. The filler is not particularly limited in its added amount, but is preferably added in an amount which is not less than 0 parts by weight and not greater than 30 parts by weight with respect to the combination agent.

There is no particular limit to a method for producing a cathode from the combination agent, which includes a mixture of the cathode active material, the conductive material, the binding agent, the various additives etc. Examples of the method include: a method which compresses the combination agent into a cathode in a shape of a pellet; and a method which (i) adds an appropriate solvent to the combination agent so as to form a paste, (ii) applies the paste onto a current collector, (iii) dries the paste, and (iv) further compresses the paste so as to form a cathode in a shape of a sheet.

The current collector carries out transfer of electrons to and from the cathode active material in the cathode. Thus, the current collector is provided to the cathode active material produced. The current collector can be a simple metal, an alloy, carbon etc. Examples of the current collector include a simple metal such as titanium and aluminum, an alloy such as stainless steel, and carbon. The current collector can alternatively be a substance, such as copper, aluminum, and stainless steel, which has a surface that is provided with a layer of carbon, titanium, or silver. The current collector can further alternatively be a substance, such as copper, aluminum, and stainless steel, which has an oxidized surface.

The current collector can have a shape of a foil, a film, a sheet, a net, or a punched-out shape. The current collector can have a structure such as a lath structure, a porous structure, a foam, and formed fibers. The current collector has a thickness which is not less than 1 μm and not greater than 1 mm. The thickness is, however, not particularly limited.

[Production of Anode]

The secondary battery of the present invention includes an anode which includes a lithium-containing material or an anode active material into which lithium can be inserted or from which lithium can be eliminated. In other words, the anode includes a lithium-containing material or an anode active material which can occlude or release lithium.

The anode active material can be a publicly known anode active material. Examples of the anode active material include (i) a lithium alloy such as metal lithium, lithium/aluminum alloy, lithium/tin alloy, lithium/lead alloy, and Wood's metal, (ii) a substance which can electrochemically dope and dedope lithium ions, such as a conducting polymer (for example, polyacetylene, polythiophene, and polyparaphenylene), pyrolysis carbon, pyrolysis carbon which has been subjected to gas-phase pyrolysis in the presence of a catalyst, carbon baked from pitch, coke, tar etc., and carbon baked from a polymer such as cellulose and phenol resin, (iii) graphite into which lithium ions can be intercalated and from which lithium ions can be deintercalated, such as natural graphite, artificial graphite, and expanded graphite, and (iv) an inorganic compound which can dope and dedope lithium ions, such as WO₂ and MoO₂. Any of the above substances can be used individually, or a complex of the above substances can be used instead.

In a case where the anode active material is, among the above substances, one of (i) pyrolysis carbon, (ii) pyrolysis carbon which has been subjected to gas-phase pyrolysis in the presence of a catalyst, (iii) carbon baked from pitch, coke, tar etc., (iv) carbon baked from a polymer, and (v) graphite such as natural graphite, artificial graphite, and expanded graphite, it is possible to produce a secondary battery which is preferable in terms of battery characteristics, especially safety. Graphite is preferably used to produce a high-voltage secondary battery, in particular.

In a case where the anode active material for the anode is a conducting polymer, carbon, graphite, an inorganic compound etc., a conductive material and a binding agent may be added to the anode active material.

The conductive material can be, for example, (i) a carbon such as carbon black, acetylene black, and Ketjen Black, (ii) graphite (either natural graphite or artificial graphite) powder, (iii) metal powder, or (iv) metal fiber. The conductive material is, however, not limited to these.

The binding agent can be, for example, (i) a fluorine polymer such as polytetrafluoroethylene and polyvinylidene fluoride, (ii) a polyolefin polymer such as polyethylene, polypropylene, and ethylene-propylene-diene terpolymer, or (iii) styrene-butadiene-rubber. The binding agent is, however, not limited to these.

[Method of Fabricating Ion Conductor and Secondary Battery]

The secondary battery of the present invention includes an ion conductor which is a publicly known ion conductor. Examples of the ion conductor include an organic electrolyte solution, a solid electrolyte (either an inorganic solid electrolyte or an organic solid electrolyte), and a molten salt. Preferable among these is an organic electrolyte solution.

The organic electrolyte solution includes an organic solvent and an electrolyte. The organic solvent is a typical, aprotic organic solvent. Examples of the organic solvent include (i) an ester such as propylene carbonate, ethylene carbonate, butylene carbonate, diethyl carbonate, dimethyl carbonate, methyl ethyl carbonate, and y-butyrolactone, (ii) a substituted tetrahydrofuran such as tetrahydrofuran and 2-methyltetrahydrofuran, (iii) an ether such as dioxolane, diethyl ether, dimethoxyethane, diethoxyethane, and methoxyethoxyethane, (iv) dimethyl sulfoxide, (v) sulfolane, (vi) methyl sulfolane, (vii) acetonitrile, (viii) methyl formate, and (ix) methyl acetate. Any of the above organic solvents can be used individually, or a mixed solvent of two or more of the above organic solvents can be used instead.

Examples of the electrolyte include a lithium salt such as lithium perchlorate, lithium borofluoride, lithium phosphofluoride, lithium arsenate hexafluoride, lithium trifluoromethanesulfonate, lithium halide, and lithium aluminate chloride. Any of the above electrolytes can be used individually, or a mixture of two or more of the electrolytes can be used instead. The above organic electrolyte solution is prepared by selecting an appropriate electrolyte for the organic solvent and dissolving the electrolyte in the organic solvent. Neither of the organic solvent and the electrolyte for use in preparing the organic electrolyte solution is limited to the above.

The inorganic solid electrolyte as the above solid electrolyte can be, for example, a nitride, halide, or oxysalt of Li. Specific examples of the inorganic solid electrolyte include Li₃N, LiI, Li₃N—LiI—LiOH, LiSiO₄, LiSiO₄—LiI—LiOH, Li₃PO₄—Li₄SiO₄, a phosphorous sulfide compound, and Li₂SiS₃.

The organic solid electrolyte as the above solid electrolyte is, for example, (i) a substance which includes the electrolyte included in the organic electrolyte and a polymer that dissociates the electrolyte or (ii) a substance which includes a polymer having an ionizable group.

Examples of the polymer that dissociates the electrolyte include a polyethylene oxide derivative, a polymer including the polyethylene oxide derivative, a polypropylene oxide derivative, a polymer including the polypropylene oxide derivative, and a phosphoric ester polymer. Alternatively, the electrolyte may contain (i) a polymer matrix material including the aprotic polar solvent, (ii) a mixture of the polymer having an ionizable group and the aprotic electrolyte, or (iii) polyacrylonitrile. A further alternative, known method is to use a combination of the inorganic solid electrolyte and the organic solid electrolyte.

The secondary battery includes a separator for retaining the electrolyte. The separator is, for example, (i) an unwoven fabric made of electrically insulating synthetic resin fiber, glass fiber, natural fiber etc., (ii) a woven fabric, (iii) a micropore structure material or (iv) a molded object of powder of, for example, alumina. Preferable among the above in terms of quality stability etc. are (i) an unwoven fabric made of a synthetic resin such as polyethylene and polypropylene and (ii) a micropore structure. In a case where the separator is an unwoven fabric made of a synthetic resin or a micropore structure, the separator is, if the battery generates an unusual amount of heat, dissolved by the heat and thus serves an additional function as a block between the cathode and the anode. It is preferable to use an unwoven fabric made of a synthetic resin or a micropore structure in terms of safety. The separator has a thickness which is not particularly limited, provided that it is thick enough to (i) retain a necessary amount of the electrolyte and (ii) prevent a short circuit between the cathode and the anode. The thickness is normally in the order of not less than 0.01 mm and not greater than 1 mm, and preferably in the order of not less than 0.02 mm and not greater than 0.05 mm.

The secondary battery can be in any shape such as a coin shape, a button shape, a sheet shape, a cylinder shape, and an angular shape. In a case where the secondary battery is in the shape of a coin or a button, the secondary battery is normally produced by (i) forming each of the cathode and the anode in a pellet shape, (ii) placing the cathode and the anode in a battery can which has a can structure with a lid, and (iii) caulking (fixing) the lid in a state in which insulating packing is sandwiched between the can and the lid.

In a case where the secondary battery is in a cylindrical or angular shape, the secondary battery is produced by (i) inserting the cathode and the anode both in a sheet shape into a battery can, (ii) electrically connecting the secondary battery to the cathode and the anode in the sheet shape, (iii) injecting the electrolyte into the battery can, and (iv) either sealing the battery can with a sealing plate via insulating packing or insulating the sealing plate from the battery can with a hermetic seal to seal the battery can. The sealing plate can be a safety valve including a safety device. The safety device is, for example, an overcurrent preventing device such as a fuse, a bimetal, and a PTC (positive temperature coefficient) device. Other than the provision of a safety valve, it is possible to, for example, open a crack in a gasket or in the sealing plate or open a cut in the battery can in order to prevent an increase in an internal pressure of the battery can. The safety device can alternatively be an external circuit operable to prevent overcharge and over discharge.

The cathode and the anode, in a case where they are both in a pellet shape or a sheet shape, are preferably dried or dehydrated in advance. The cathode and the anode can be dried or dehydrated by a normal method. The method is, for example, to use (i) solely any one of or (ii) any combination of hot air, vacuum, infrared radiation, far infrared radiation, electron rays, low-moisture air etc. The cathode and the anode are preferably dried or dehydrated at a temperature which is not less than 50° C. and not greater than 380° C.

The electrolyte is injected into the battery can by, for example, a method of applying an injection pressure to the electrolyte or a method that utilizes a difference between a negative pressure and an atmospheric pressure. The method is, however, not limited to these. Further, the electrolyte is injected in an amount that is not particularly limited. The amount is, however, preferably an amount which allows the cathode, the anode, and the separator to be entirely immersed in the electrolyte.

The secondary battery thus produced is charged and discharged by a constant-current charging/discharging method, a constant-voltage charging/discharging method, or a constant-power charging/discharging method. The method is preferably selected according to a purpose of evaluating the battery. The secondary battery can be charged and discharged solely by any one of the above methods or by a combination of any of the above methods.

Since the cathode of the secondary battery of the present invention includes the above cathode active material, it is possible to reduce the solving out of Mn. Consequently, it is possible to produce a nonaqueous secondary battery having greatly improved cycle characteristics. Further, the nonaqueous secondary battery thus produced is less likely to have a reduced discharge capacity.

The present invention encompasses the embodiments below.

The cathode active material of the present invention may preferably be arranged such that the sub crystalline phase has a crystal structure which is either a tetragonal crystal or an orthorhombic crystal.

In a case where the sub crystalline phase has the above structure, the sub crystalline phase can desirably be present on an interface of the main crystalline phase with higher affinity.

The cathode active material of the present invention may preferably be arranged such that the sub crystalline phase has a spinel structure.

In a case where the sub crystalline phase has a spinel structure, the sub crystalline phase can desirably be present on an interface of the main crystalline phase with higher affinity.

The cathode active material of the present invention may preferably be arranged such that the sub crystalline phase has a crystallinity which is detectable by diffractometry. Examples of the diffractometry include X-ray diffractometry, neutron diffractometry, and electron diffractometry.

The sub crystalline phase as above has a high crystallinity. As such, in the case where the cathode active material is used as a cathode material of a nonaqueous secondary battery, it is possible to physically prevent expansion or shrinkage of the cathode active material which expansion or shrinkage is caused when lithium is eliminated from or inserted into the main crystalline phase. With the above arrangement, crystal particles included in the cathode active material are less likely to be deformed. As a result, it is possible to (i) reduce the risk of, for example, a crack occurring in the crystal particles and consequently to (ii) provide a cathode active material that enables production of a nonaqueous secondary battery which is less likely to have a reduced discharge capacity.

The cathode active material of the present invention may preferably be arranged such that an intermediate phase is present at an interface between the main crystalline phase and the sub crystalline phase, the intermediate phase including at least a part of an element of the main crystalline phase and at least a part of an element of the sub crystalline phase.

The above interface in the cathode active material allows the main crystalline phase and the sub crystalline phase to strongly bond to each other, and consequently enables production of a cathode active material in which a crack etc. is even less likely to occur.

The cathode active material of the present invention may preferably be arranged such that 0.01×0.10 in General Formula A below, which represents an overall composition of the cathode active material, the overall composition including the main crystalline phase and the sub crystalline phase,

Li₁₋ₓM1₂₋₂ₓM2ₓM3₂ₓO_{4-y}, General Formula A

where M1 is either manganese or a combination of manganese and at least one transition metal element other than manganese; M2 and M3 are each at least one representative metal element or at least one transition metal element; M1, M2, and M3 are different from one another; and y is a value which satisfies electrical neutrality with x.

In the case where x falls within the above range, it is possible to achieve preferable proportions for the main crystalline phase and the sub crystalline phase. Further, in a case where the cathode active material is used as a cathode material of a nonaqueous secondary battery, it is possible to achieve a suitable balance between (i) prevention of reduction in discharge capacity of the nonaqueous secondary battery and (ii) improvement of cycle characteristics of the nonaqueous secondary battery.

The cathode active material of the present invention may preferably be arranged such that the lithium-containing transition metal oxide contains only manganese as a transition metal.

In the above case, the lithium-containing transition metal oxide can be synthesized easily. As such, it is possible to simplify a process of producing the cathode active material.

The cathode active material of the present invention may preferably be arranged such that the sub crystalline phase includes a representative element and manganese.

With the above arrangement, it is possible to further stabilize the sub crystalline phase which bonds to the main crystalline phase via an identical oxygen arrangement. As a result, it is possible to further reduce the solving out of Mn from the main crystalline phase.

The cathode active material of the present invention may preferably be arranged such that the sub crystalline phase includes zinc and manganese.

In a case where the sub crystalline phase includes zinc and manganese, it is possible to remarkably stabilize the sub crystalline phase which bonds to the main crystalline phase via an identical oxygen arrangement. As a result, it is possible to particularly desirably reduce the solving out of Mn from the main crystalline phase.

The cathode active material of the present invention may preferably be arranged such that the sub crystalline phase has a composition ratio Mn/Zn of the zinc and the manganese which composition ratio Mn/Zn is 2≦Mn/Zn<4.

In a case where the composition ratio of manganese and zinc falls within the above range, it is desirably possible to further reduce the solving out of Mn.

The cathode active material of the present invention may preferably be arranged such that the sub crystalline phase has a thickness which is not less than 1 nm and not greater than 100 nm.

In a case where the sub crystalline phase has a thickness within the above range, (i) it is possible to ensure that the sub crystalline phase has a thickness which allows it to desirably reduce the solving out of Mn, and (ii) the sub crystalline phase is less likely to have a thickness so large as to prevent Li ions from moving from the cathode active material.

The cathode active material of the present invention may preferably be arranged such that the lithium-containing transition metal oxide has a lattice constant which is not less than 8.22 Å and not greater than 8.25 Å.

With the above arrangement, the lattice constant of the lithium-containing transition metal oxide matches a distance between and arrangement of oxygen atoms on any plane of the sub crystalline phase which is identical in oxygen arrangement to the main crystalline phase. This allows the sub crystalline phase to bond to the main crystalline phase with good affinity. As such, the sub crystalline phase can stably be present on the interface of the main crystalline phase.

The cathode active material of the present invention may preferably be arranged such that the sub crystalline phase and the main crystalline phase part are formed in such a manner that a 011 plane of the main crystalline phase part and a 001 plane of the sub crystalline phase are adjacent to each other.

With the arrangement, a distance between and arrangement of oxygen atoms on the 011 plane of the main crystalline phase part are equal to a distance between and arrangement of oxygen atoms on the 001 plane of the sub crystalline phase. This allows the sub crystalline phase to bond to the main crystalline phase with better affinity. As such, the sub crystalline phase can more stably be present on the interface of the main crystalline phase.

A nonaqueous secondary battery of the present invention is a nonaqueous secondary battery, including: a cathode; an anode; and a nonaqueous ion conductor, the anode including either (i) a substance containing lithium or) an anode active material into which lithium is capable of being inserted or from which lithium is capable of being eliminated, the cathode including any one of the above cathode active materials.

The nonaqueous secondary battery includes a cathode which includes the above cathode active material. As such, it is possible to reduce the solving out of Mn, and consequently allow production of a nonaqueous electrolyte secondary battery having greatly improved cycle characteristics. The nonaqueous electrolyte secondary battery thus produced is less likely to have a reduced discharge capacity.

### EXAMPLES

The following description deals in further detail with the present invention in reference to Examples. The present invention is, however, not limited to the description of Examples. Measurements described below were made on bipolar cells (secondary batteries) and cathode active materials produced in Examples and Comparative Examples below.

<Charging/Discharging Cycle Test>

Charging/discharging cycle tests were conducted on obtained bipolar cells under conditions of (i) a current density of 0.5 mA/cm², (ii) a voltage ranging from 3.2 V to 4.3 V, and (iii) temperatures of 25° C. and 60° C.

Under the condition of 25° C., discharge capacity maintenance rates were calculated from {(discharge capacity after 200 cycles)/(initial discharge capacity)}×100. The initial discharge capacity refers to a mean value of respective discharge capacities observed after 6 cycles through 10 cycles. The discharge capacity after 200 cycles refers to a mean value of respective discharge capacities observed after 198 cycles through 202 cycles.

Under the condition of 60° C., discharge capacity maintenance rates were calculated from {(discharge capacity after 100 cycles)/(initial discharge capacity)}×100. The initial discharge capacity refers to a mean value of respective discharge capacities observed after 6 cycles through 10 cycles. The discharge capacity after 100 cycles refers to a mean value of respective discharge capacities observed after 98 cycles through 102 cycles.

<Photographing HAADF-STEM Image>

Particles of each cathode active material obtained were attached to a resin including silicon as a main component. The particles of the cathode active material were each processed into a 10-μm cube with use of Ga ions. The particles were further irradiated with a Ga ion beam in a single direction so that a thin film sample for STEM-EDX analysis was obtained which sample had a thickness of not less than 100 nm and not greater than 150 nm.

The thin film sample for STEM-EDX analysis was observed under a field-emission electron microscope (HRTEM; manufactured by HITACHI Co. Ltd., model No. HF-2210) under conditions of (i) an accelerating voltage of 200 kV, (ii) a sample absorption current of 10⁻⁹ A, and (iii) a beam diameter of 0.7 nmφ, to obtain a HAADF-STEM image.

<Photographing EDX-Element Map>

The thin film sample for STEM-EDX analysis, which sample was obtained for the STEM image photographing, was irradiated with a beam for 40 minutes under the field-emission electron microscope (HRTEM; manufactured by HITACHI Co. Ltd., model No. HF-2210) under conditions of (i) an accelerating voltage of 200 kV, (ii) a sample absorption current of 10⁻⁹ A, and (iii) a beam diameter of 1 nmφ, to obtain an EDX-element map.

<Electron Diffraction>

The thin film sample for STEM-EDX analysis, which was obtained by photographing the STEM image, was subjected to electron diffraction using the field-emission electron microscope (HRTEM; manufactured by HITACHI Co. Ltd., model No. HF-2210) under conditions of (i) an accelerating voltage of 200 kV, (ii) a sample absorption current of 10⁻⁹ A, and (iii) a beam diameter of 2 nmφ, to carry out electron diffraction. The crystal orientation of the sample was examined based on the resulting electron diffraction pattern.

<Photographing Lattice Image>

The thin film sample for STEM-EDX analysis, which was obtained by photographing the STEM image, was observed with the field-emission electron microscope (HRTEM; manufactured by HITACHI Co. Ltd., model No. HF-2210) under conditions of (i) an accelerating voltage of 200 kV, (ii) a sample absorption current of 10⁻⁹ A, and (iii) a beam diameter of 0.7 nmφ, to capture a lattice image under observation with a large magnification of 20000 or greater.

### Example 1

The present example used (i) zinc oxide as a zinc source material and (ii) tin oxide (IV) as a tin source material. These materials were weighed so that the zinc and the tin would have a molar ratio of 2:1. The materials were then mixed for 5 hours in an automated mortar. The mixture was next baked at 1000° C. for 12 hours in an air atmosphere, so that a baked product was obtained. After the baking, the baked product thus obtained was crushed and mixed in an automated mortar for 5 hours, so that a spinel-type compound was produced.

The present example further used (i) lithium carbonate as a lithium source material for providing a lithium-containing oxide and (ii) electrolytic manganese dioxide as a manganese source material. These materials were weighed so that the lithium and the manganese would have a molar ratio of 1:2. Further, the spinel-type compound was weighed so that the spinel-type compound and the main crystalline phase would achieve x=0.05 in General Formula A. The lithium carbonate, the electrolytic manganese dioxide, and the spinel-type compound were mixed with one another in an automated mortar for 5 hours, and then pre-baked at 550° C. for 12 hours in an air atmosphere (pre-baking step). Next, a resulting baked product was crushed and mixed in an automated mortar for 5 hours, so that powder was obtained.

The powder was molded into a pellet shape and then baked at 800° C. for 12 hours in an air atmosphere (baking step). A resulting baked product was next crushed and mixed in an automated mortar for 5 hours, so that a cathode active material was obtained.

The cathode active material at 80 parts by weight was mixed with (i) 15 parts by weight of acetylene black as the conductive material and (ii) 5 parts by weight of polyvinylidene fluoride as the binding agent. The mixture was then further mixed with N-methylpyrrolidone so as to be in a paste form. The paste was applied onto a 20-μm-thick aluminum foil so as to have a thickness of not less than 50 μm and not greater than 100 μm. The applied paste was dried and then punched so as to provide a disk having a diameter of 15.958 mm. The disk was then vacuum-dried, so that a cathode was produced.

The present example produced an anode by punching a metal lithium foil having a predetermined thickness, so that a disk having a diameter of 16.156 mm was Obtained. The present example prepared a nonaqueous electrolytic solution as the nonaqueous electrolyte by (i) mixing ethylene carbonate with dimethyl carbonate at a volume ratio of 2:1 into a solvent, and (ii) dissolving LiPF₆ as a solute at 1.0 mol/l in the solvent. The present example used as the separator a porous polyethylene film having a thickness of 25 μm and a porosity of 40%.

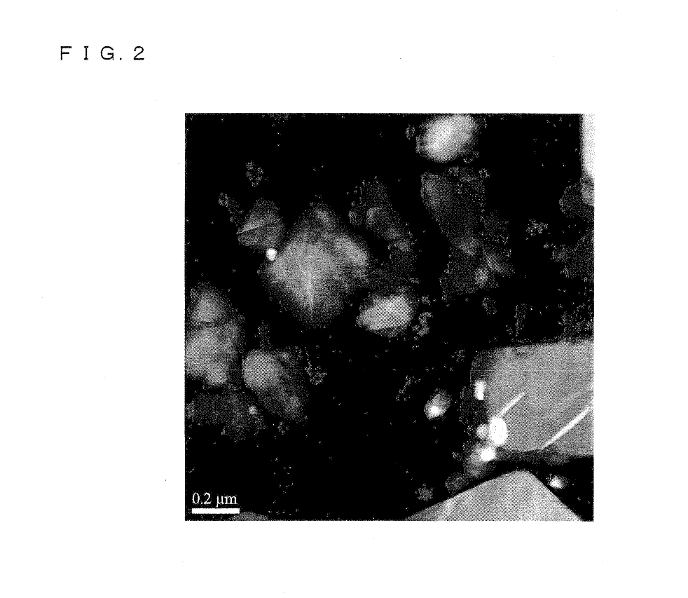

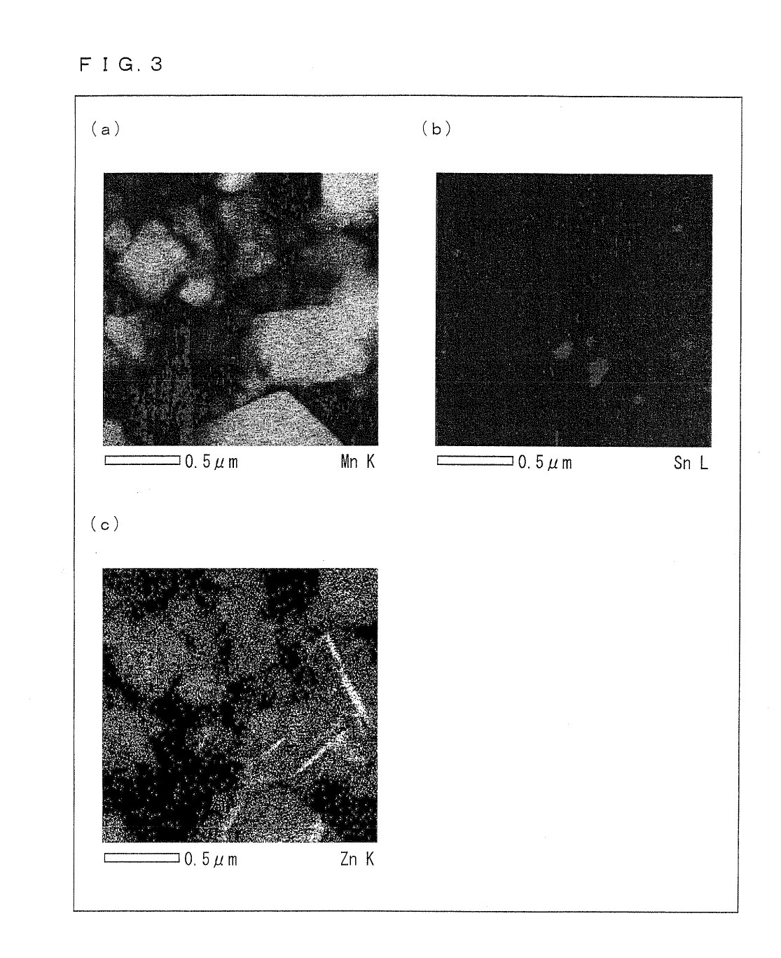

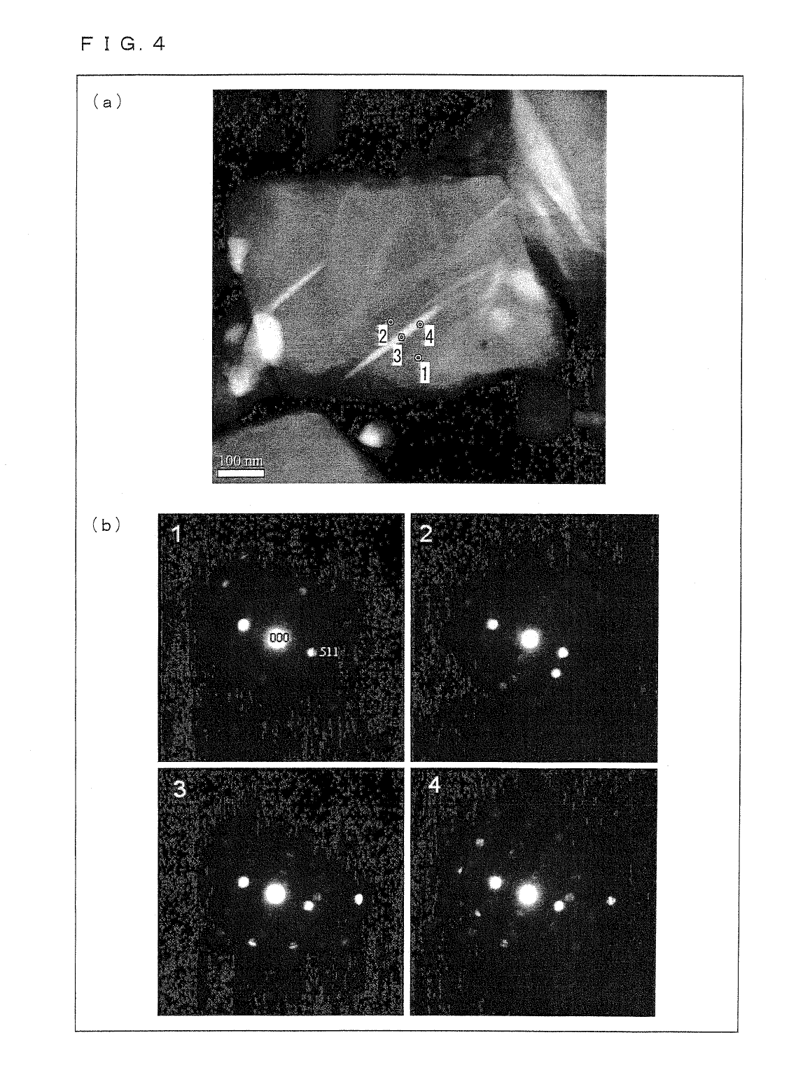

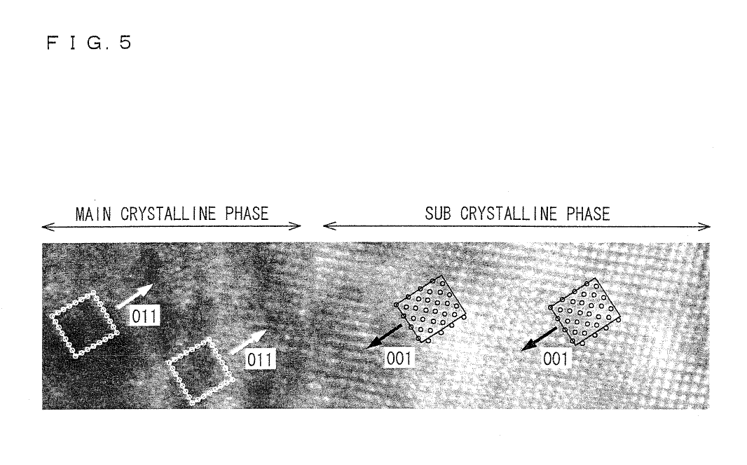

The cathode, the anode, the nonaqueous electrolytic solution, and the separator were combined with one another to produce a bipolar cell. A charging/discharging cycle test was conducted on the bipolar cell thus obtained. Table 1 shows results of measurements of initial discharge capacities and discharge capacity maintenance rates at 25° C. after the cycle test. Table 2 shows results of measurements of initial discharge capacities and discharge capacity maintenance rates at 60° C. after the cycle test. The above-obtained cathode active material was photographed to provide a HAADF-STEM image, an EDX-element map, electron diffraction, and a lattice image. FIG. 2 is a drawing showing a photographed HAADF-STEM image of the cathode active material obtained in Example 1. FIG. 3 is a drawing showing photographed EDX-element map of the cathode active material obtained in Example 1. (a) of FIG. 4 is a drawing showing a part of the photographed HAADF-STEM image shown in FIG. 2. (b) of FIG. 4 is an electron diffraction pattern of the cathode active material obtained in Example 1. FIG. 5 is a drawing showing a photographed lattice image of the cathode active material obtained in Example 1.

The HAADF-STEM image analyzes, entirely in a thickness direction, a part irradiated with a beam. FIGS. 2 and 3 thus show that the zinc and tin contained in the spinel-type compound were in a layer shape with respect to the manganese contained in the main crystalline phase. This clearly indicates that the spinel-type compound (sub crystalline phase) was in a layer shape in the cathode active material.

In the HAADF-STEM image shown in (a) of FIG. 4, reference numbers 1 and 2 indicate the main crystalline phase, and 3 and 4 indicate a phase including both the main crystalline phase and the sub crystalline phase. 3 and 4 are positioned between 1 and 2. As is seen from (b) of FIG. 4, the reference numbers 1, 2, and 3 exhibit substantially the same electron diffraction pattern. Exhibiting substantially the same electron diffraction pattern indicates having substantially the same crystal orientation. This clearly indicates that the main crystalline phase part around the sub crystalline phase has the same crystal orientation as that of the sub crystalline phase.

Further, it is seen from the lattice image shown in FIG. 5 that the main crystalline phase part is adjacent to the sub crystalline phase. Further, as a result of analysis of the lattice image, it was found that crystal planes in FIG. 5 were such that the main crystalline phase part had a 011 plane and the sub crystalline phase had a 001 plane. This indicates that the 011 plane of the main crystalline phase part is adjacent to the 001 plane of the sub crystalline phase.

### Example 2

The present example carried out a synthesis process in a manner similar to that of Example 1 except that the mixture ratio x of the spinel-type compound in General Formula A is changed from 0.05 to 0.02. A bipolar cell was produced by a method similar to that of Example 1. A charging/discharging cycle test was conducted on the bipolar cell. Tables 1 and 2 show results of the charging/discharging cycle test.

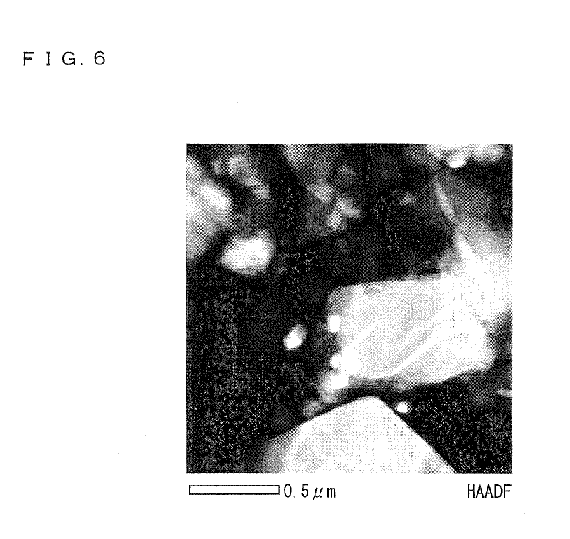

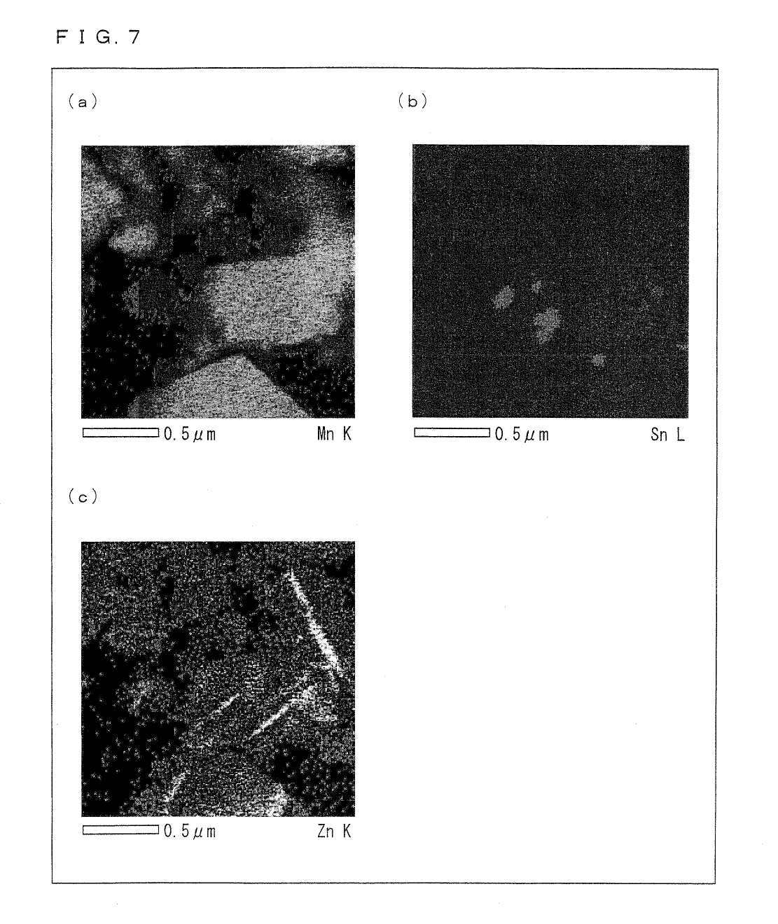

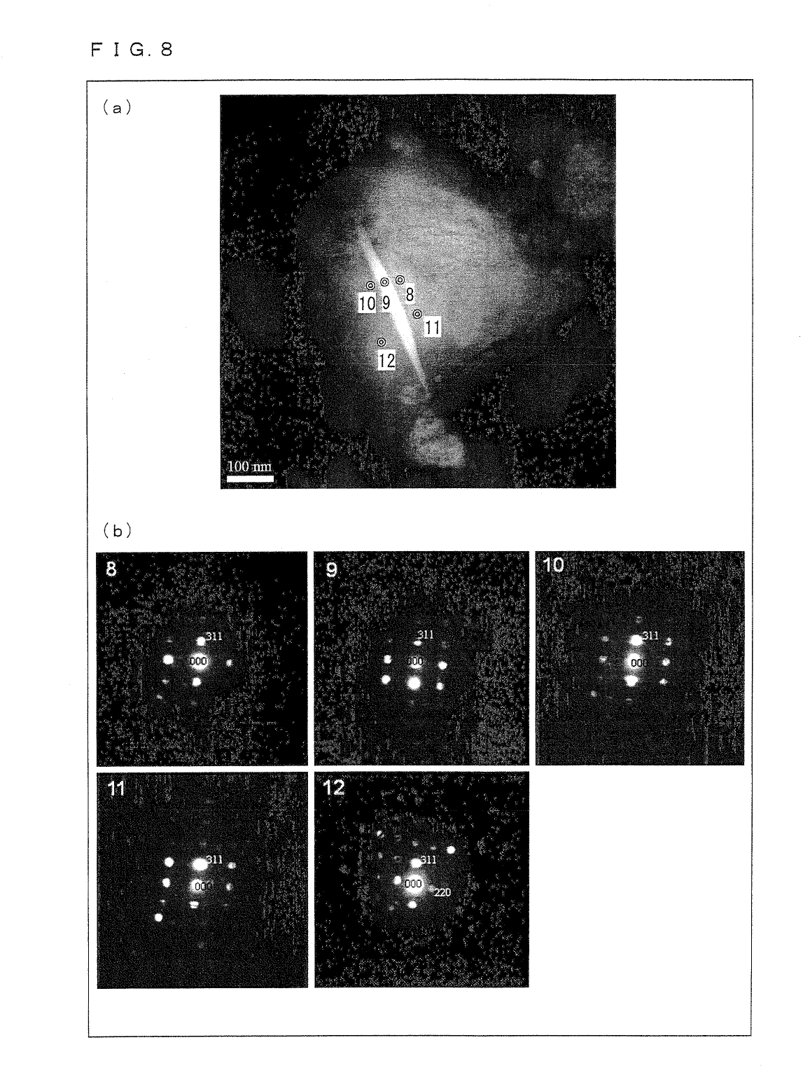

A sample for STEM-EDX analysis was obtained by a method similar to that of Example 1. Further, the sample was photographed in a manner similar to that of Example 1 and drawings showing a photographed HAADF-STEM image (FIG. 6, (a) of FIG. 8), a photographed EDX-element map (FIG. 7), and an electron diffraction pattern ((b) of FIG. 8) were obtained.

It was confirmed from FIGS. 6 and 7 that the spinel-type compound (sub crystalline phase) was in a layer shape in the main crystalline phase of the cathode active material, similarly with Example 1. Further, in the HAADF-STEM image shown in (a) of FIG. 8, reference numbers 8, 10, 11, and 12 indicate the main crystalline phase, and 9 indicates a phase including both the main crystalline phase and the sub crystalline phase. Similarly with Example 1, the reference number 9 is positioned between 8 and 10. As is seen from (b) of FIG. 8, the reference numbers 8, 9, and 10 exhibit substantially the same electron diffraction pattern. This clearly indicates that the main crystalline phase part around the sub crystalline phase has the same crystal orientation as that of the sub crystalline phase.

### Example 3

The present example carried out a synthesis process in a manner similar to that of Example 1 except that the mixture ratio x of the spinel-type compound in General Formula A was changed from 0.05 to 0.10. A bipolar cell was produced by a method similar to that of Example 1. A charging/discharging cycle test was conducted on the bipolar cell. Tables 1 and 2 show results of the charging/discharging cycle test.

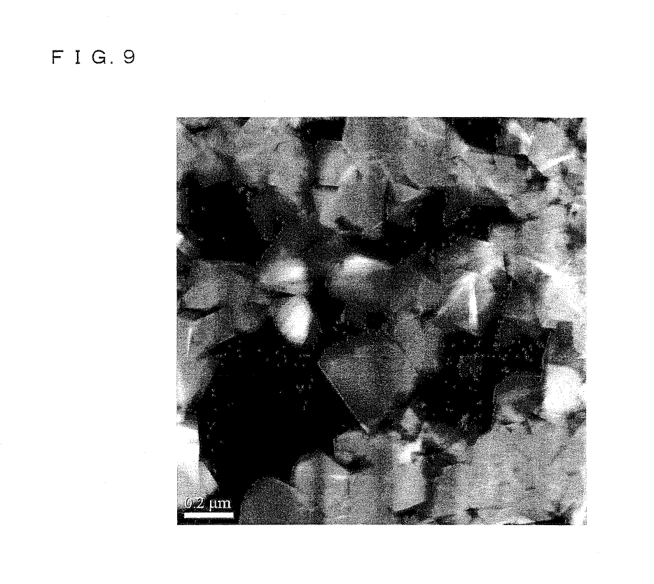

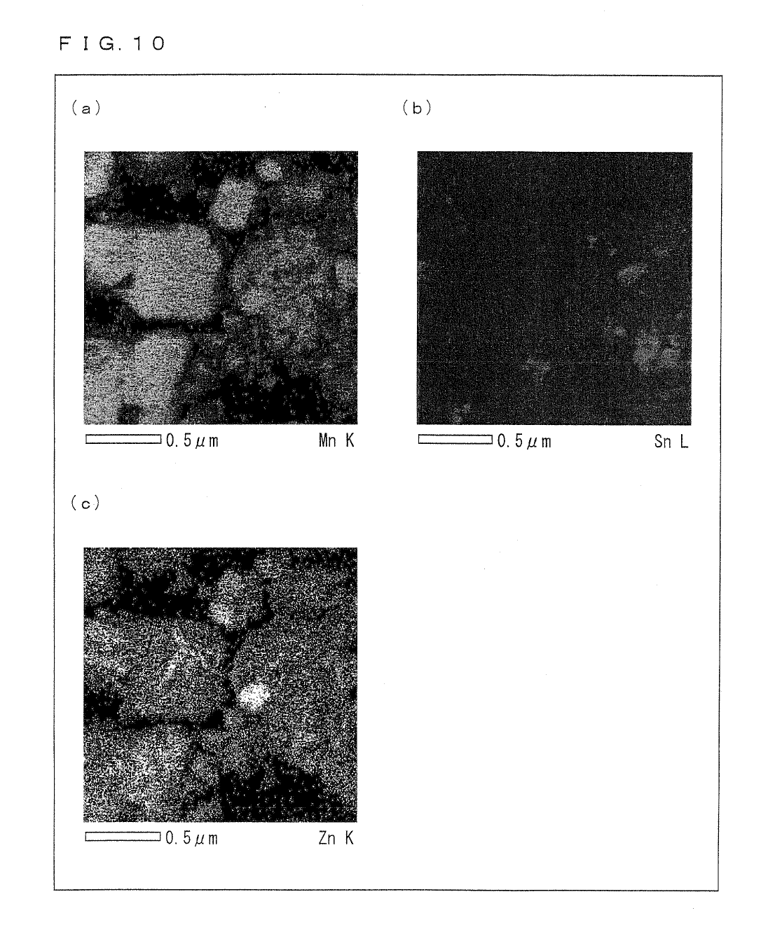

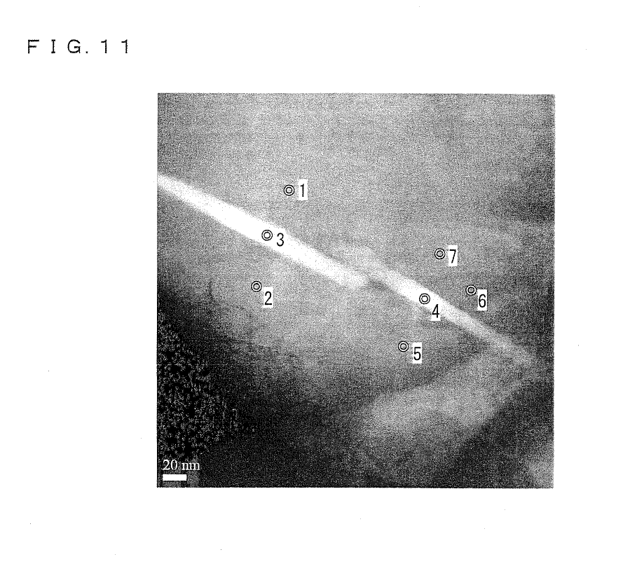

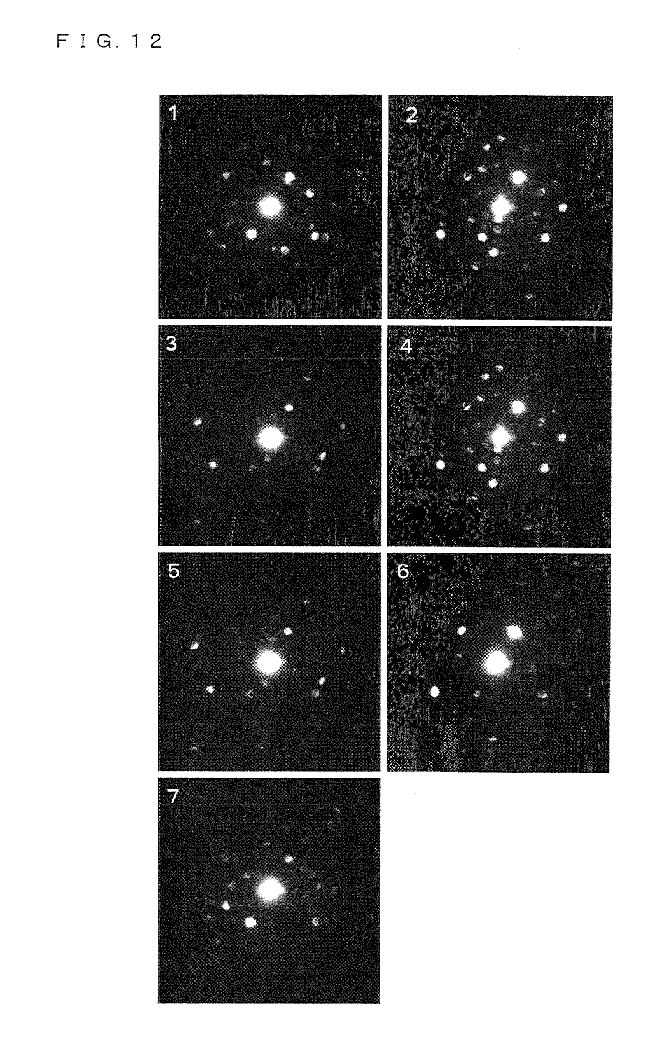

A sample for STEM-EDX analysis was obtained by a method similar to that of Example 1. Further, the cathode active material was photographed in a manner similar to that of Example 1 and drawings showing a photographed HAADF-STEM image (FIGS. 9 and 11), a photographed EDX-element map (FIG. 10), and an electron diffraction pattern (FIG. 12) were obtained.

It was confirmed from FIGS. 9 and 10 that the spinel-type compound (sub crystalline phase) was in a layer shape in the main crystalline phase of the cathode active material, similarly with Example 1. Further, in FIG. 11, reference numbers 1, 2, 5, 6, and 7 indicate the main crystalline phase, and 3 and 4 indicate a phase including both the main crystalline phase and the sub crystalline phase. Similarly with Example 1, the reference number 3 is positioned between 1 and 2, and 4 is positioned between 5, 6, and 7. Similarly with Example 1, the reference numbers 1 to 7 exhibit substantially the same electron diffraction pattern. This clearly indicates that the main crystalline phase part around the sub crystalline phase has the same crystal orientation as that of the sub crystalline phase.

### Comparative Example 1

The present example used (i) lithium carbonate as a lithium source material and (ii) electrolytic manganese dioxide as a manganese source material, without involving mixing of any spinel-type compound. The starting materials were weighed so that the lithium and the manganese would have a molar ratio of 1:2. The lithium carbonate and the electrolytic manganese dioxide were mixed with each other in an automated mortar for 5 hours, and then pre-baked at 550° C. for 12 hours in an air atmosphere. Next, a resulting baked product was crushed and mixed in an automated mortar for 5 hours, so that powder was obtained.

The powder was molded into a pellet shape and then baked at 800° C. for 12 hours in an air atmosphere. A resulting baked product was next crushed and mixed in an automated mortar for 5 hours, so that a cathode active material was obtained. A bipolar cell was produced by a method similar to that of Example 1. A charging/discharging cycle test was conducted on the bipolar cell. Tables 1 and 2 show results of the charging/discharging cycle test.

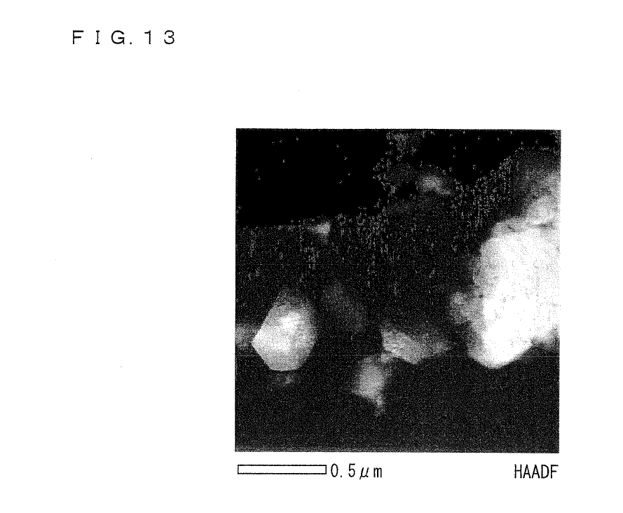

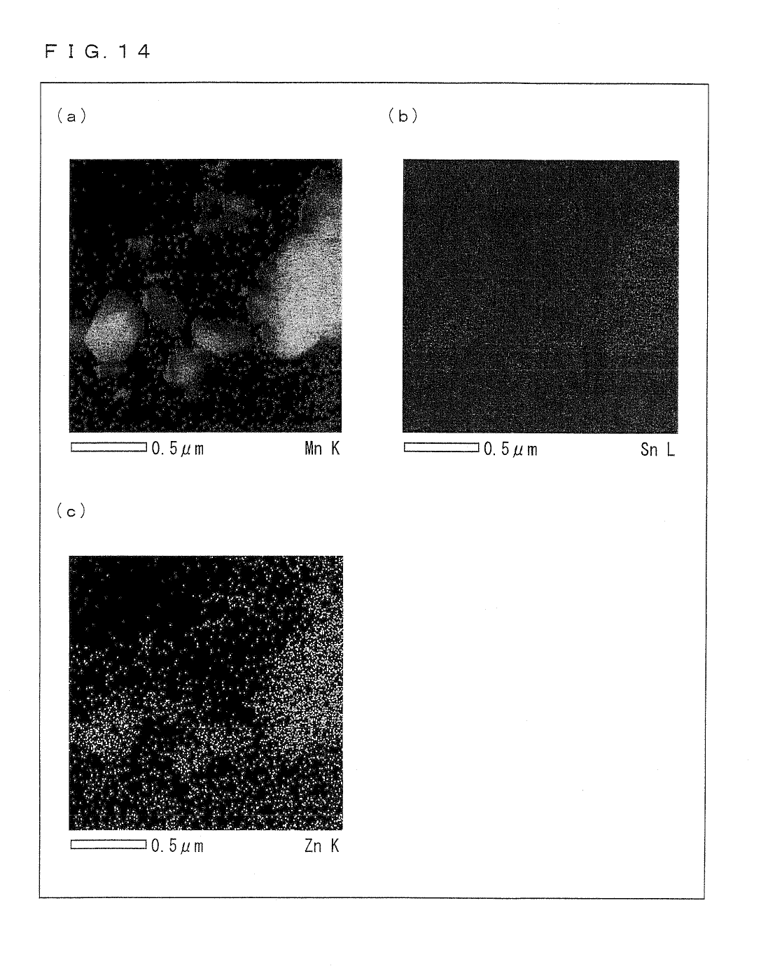

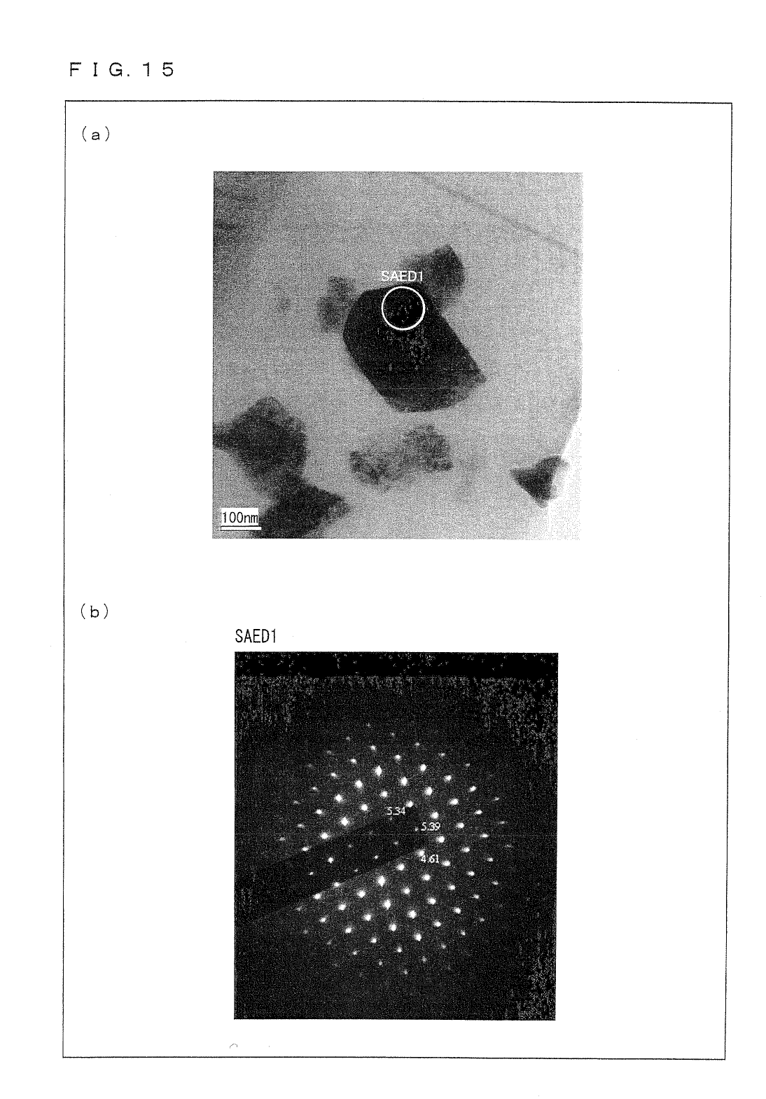

A sample for STEM-EDX analysis was obtained by a method similar to that of Example 1. Further, the cathode active material was photographed in a manner similar to that of Example 1 and drawings showing a photographed HAADF-STEM image (FIG. 13 and (a) of FIG. 15), a photographed EDX-element map (FIG. 14), and an electron diffraction pattern ((b) of FIG. 15) were obtained.

As seen from FIGS. 13 and 14, sub-crystalline phase could not be observed unlike Examples 1-3. In FIG. 14, according to the EDX analysis, a specific element was detected at a portion where no element existed. This shows that element maps of Zn and Sn obtained as a result of the EDX analysis were derived from noises. (b) of FIG. 15 is an electron diffraction pattern showing a part indicated by SAED1 in (a) of FIG. 15. This is an electron diffraction pattern showing only the main crystalline phase.

### Comparative Example 2

The starting material prepared in Comparative Example 1 and the spinel-type compound prepared in Example 1 were weighed so that a molar ratio of the starting material to the spinel-type compound was 95:5, and then the starting material and the spinel-type compound were mixed in an automated mortar for 5 hours to obtain a synthesized cathode active material. Further, a bipolar cell was produced by a method similar to that of Example 1. A charging/discharging cycle test was conducted on the bipolar cell. Tables 1 and 2 show results of the charging/discharging cycle test.

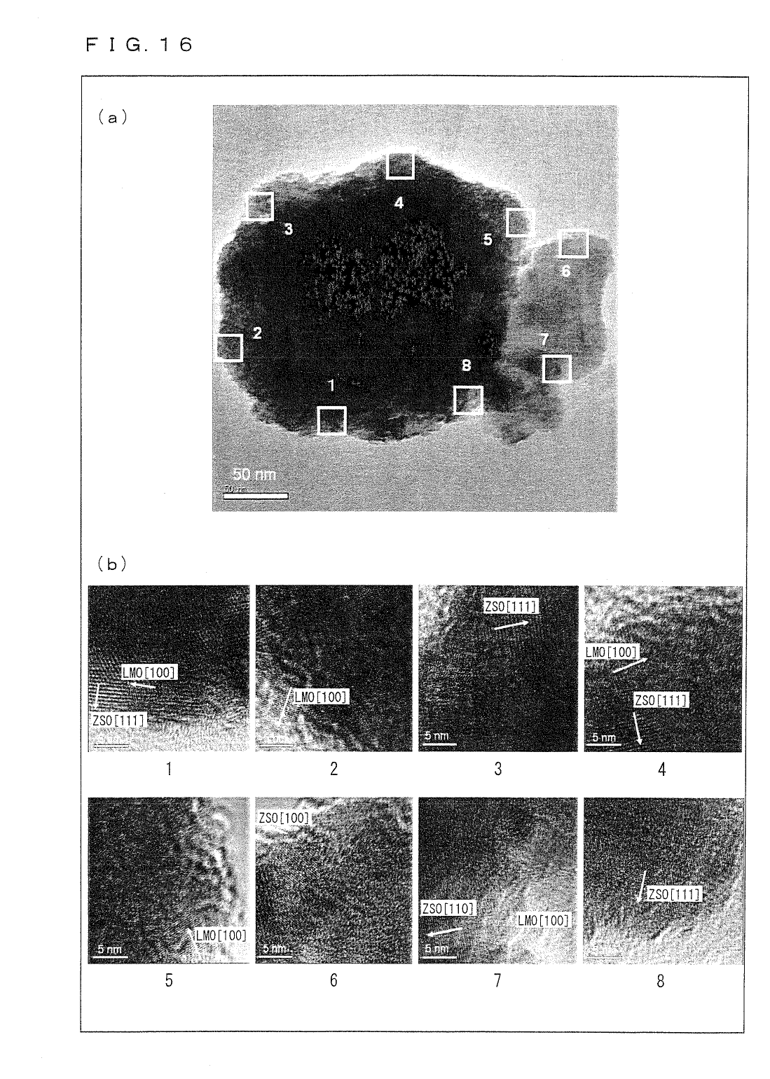

A sample for STEM-EDX analysis was obtained by a method similar to that of Example 1. Further, the cathode active material was photographed in a manner similar to that of Example 1 and drawings showing a photographed HAADF-STEM image ((a) of FIG. 16) and an electron diffraction pattern ((b) of FIG. 16) were obtained.

It is seen from (a) of FIG. 16 that the sub crystalline phase exists at the grain boundary of the main crystalline phase, unlike Examples 1-3 in which the sub crystalline phase was formed inside the main crystalline phase. Further, it is confirmed from 1-8 of (b) of FIG. 16 that the 111 plane of oxide Zn₂SnO₄ which is different from the main crystalline phase and the 100 plane of the main crystalline phase were adjacent to each other.

TABLE 1
Results of charging/discharging cycle test at 25° C.

| | Discharge capacity |
|---|---|
| | maintenance rate (%) |
| Example 1 | 90 |
| Example 2 | 87 |
| Example 3 | 91 |
| Comparative Example 1 | 80 |
| Comparative Example 2 | 80 |

TABLE 2
Results of charging/discharging cycle test at 60° C.

| | | Discharge capacity |
|---|---|---|
| | Initial discharge | maintenance rate |
| | capacity (mAh/g) | (%) |
| Example 1 | 91 | 73 |
| Example 2 | 90 | 65 |
| Example 3 | 76 | 84 |
| Comparative | | |
| Example 1 | 120 | 43 |
| Comparative | | |
| Example 2 | 114 | 43 |

Tables 1 and 2 show that good values were achieved for the discharge capacity maintenance rates of the bipolar cell in Examples 1 through 3. Tables 1 and 2 show, however, that the discharge capacity maintenance rates in Comparative Examples 1 and 2 had low values. Comparative Examples 1 and 2 are poor in this respect as compared to Examples 1 through 3. Examples 1 through 3 had respective initial discharge capacities of not less than 76 mAh/g. This indicates that Examples 1 through 3 each achieved good values for both the initial discharge capacity and the discharge capacity maintenance rate.

The cathode active material of Comparative Example 1, with which no spinel-type compound was mixed during the production process, contained no sub crystalline phase. Further, although the spinel-type compound was mixed with the cathode active material of Comparative Example 2 during the production process, the sub crystalline phase is not formed inside the main crystalline phase in Comparative Example 2. This cathode active material had low values for the discharge capacity maintenance rates at 25° C. and 60° C.

As described above, the cathode of the secondary battery of the present invention includes the above cathode active material as a cathode material. In the cathode active material, the sub crystalline phase is formed inside the main crystalline phase, and the crystal orientation of the main crystalline phase part around the sub crystalline phase and the crystal orientation of the sub crystalline phase are equal to each other. It was found that cycle characteristics exhibited by a secondary battery at high temperatures were improved by use of the cathode active material. Further, existence of the sub crystalline phase in the cathode active material can decrease reduction in discharge capacity which reduction is caused by, for example, a crack in crystal particles in the cathode active material. As such, with the present invention, it is possible to provide a secondary battery which exhibits a significantly high performance.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The cathode active material of the present invention is applicable in a nonaqueous secondary battery for use in, for example, a portable information terminal, a portable electronic device, a small-size household power storage device, a motor-powered electric bicycle, an electric vehicle, and a hybrid electric vehicle.

### REFERENCE SIGNS LIST

1 cathode active material
2 main crystalline phase
2′ main crystalline phase part
3 sub crystalline phase

1. A cathode active material for use in a nonaqueous secondary battery, the cathode active material comprising:
a main crystalline phase including a lithium-containing transition metal oxide containing manganese and having a spinel structure; and
a sub crystalline phase contained in the main crystalline phase, the sub crystalline phase being identical in oxygen arrangement to the lithium-containing transition metal oxide and different in elementary composition from the lithium-containing transition metal oxide,
a main crystalline phase part around the sub crystalline phase and the sub crystalline phase having a same crystal orientation.

2. The cathode active material according to claim 1, wherein:
the sub crystalline phase has a crystal structure which is either a tetragonal crystal or an orthorhombic crystal.

3. The cathode active material according to claim 1, wherein:
the sub crystalline phase has a spinel structure.

4. The cathode active material according to claim 1, wherein:
the sub crystalline phase has a crystallinity which is detectable by diffractometry.

5. The cathode active material according to claim 1, wherein:
an intermediate phase is present at an interface between the main crystalline phase and the sub crystalline phase, the intermediate phase including at least a part of an element of the main crystalline phase and at least a part of an element of the sub crystalline phase.

6. The cathode active material according to claim 1, wherein:
0.01≦x≦0.10 in General Formula A below, which represents an overall composition of the cathode active material, the overall composition including the main crystalline phase and the sub crystalline phase,
Li₁₋ₓM1₂₋₂ₓM2ₓM3₂ₓO_{4-y}, General Formula A
where M1 is either manganese or a combination of manganese and at least one transition metal element other than manganese; M2 and M3 are each at least one representative metal element or at least one transition metal element; M1, M2, and M3 are different from one another; and y is a value which satisfies electrical neutrality with x.

7. The cathode active material according to claim 1, wherein:
the lithium-containing transition metal oxide contains only manganese as a transition metal.

8. The cathode active material according to claim 1, wherein:
the sub crystalline phase includes a representative element and manganese.

9. The cathode active material according to claim 8, wherein:
the sub crystalline phase includes zinc and manganese.

10. The cathode active material according to claim 9, wherein:
the sub crystalline phase has a composition ratio Mn/Zn of the zinc and the manganese which composition ratio Mn/Zn is 2≦Mn/Zn<4.

11. The cathode active material according to claim 1, wherein:
the sub crystalline phase has a thickness which is not less than 1 nm and not greater than 100 nm.

12. The cathode active material according to claim 1, wherein:
the lithium-containing transition metal oxide has a lattice constant which is not less than 8.22 Å and not greater than 8.25 Å.

13. The cathode active material according to claim 1, wherein:
the sub crystalline phase and the main crystalline phase part are formed in such a manner that a 011 plane of the main crystalline phase part and a 001 plane of the sub crystalline phase are adjacent to each other.

14. A nonaqueous secondary battery, comprising:
a cathode;
an anode; and
a nonaqueous ion conductor,
the anode including either (i) a substance containing lithium or (ii) an anode active material into which lithium is capable of being inserted or from which lithium is capable of being eliminated,
the cathode including the cathode active material according to claim 1.
